(19) United States
(12) Patent Application Publication
(10) Pub. No.: US 2022/0164888 A1
(43) Pub. Date: May 26, 2022

(54) Insurance Management Server, Service Providing System, and Service Providing Method

(71) Applicant: WARRANTEE INC., Osaka-shi, Osaka (JP)

(72) Inventor: Yusuke SHONO, Osaka (JP)

(21) Appl. No.: 17/440,785

(22) PCT Filed: Mar. 19, 2020
(86) PCT No.: PCT/JP2020/012512

§ 371 Date: Sep. 19, 2021

(30) Foreign Application Priority Data
Mar. 20, 2019 (JP) 2019-053356

(51) Int. Cl. G06Q 40/08; G06Q 30/06

(52) U.S. Cl. CPC G06Q 40/08; G06Q 30/0631

(57) ABSTRACT

To reduce the burden on a user, and promote the purchase of insurance or other equivalent services. A management server 10, which is connected to a user terminal 20 used by a user, an insurer's terminal 30 used by an insurer, and a sponsor's terminal 40 used by a sponsor through a communication network, receives information about insurance products from the insurer's terminal 30, receives information about purchase conditions of the insurance products from the sponsor 'terminal 40, and determines whether to permit the user to purchase the service by at least partially referring to the purchase conditions received from the sponsor's terminal 40, when an application for the service purchase is received from the user terminal 20.

### TECHNICAL FIELD

The present invention relates to a system and the like to provide a specific service, such as insurance and product repair, for users. Specifically, the present invention relates to a system and the like where a sponsor covers a part of or all the cost pertaining to services, such as insurance, provided to users to promote user's purchase of the service.

### BACKGROUND ART

Conventionally, there has been known an insurance management system that includes an insurant terminal used by a user, an insurer's terminal used by an insurer, and an insurance management device connected to these devices through the Internet (Patent Document 1). In this insurance management system, information on insurance products provided by the insurer has been aggregated in the insurance management device. When a user applies for insurance purchase, the insurance management device is to determine whether the user meets purchase conditions of insurance products or the benefit conditions of insurance products.

Patent Document 1: JP2018-180863 A

### DISCLOSURE OF THE INVENTION

### Problems to be Solved by the Invention

Conventional insurances and services similar thereto have been designed to level the risks by all the insurants to take a precaution against potential risks inherent when it becomes apparent, and the cost incurred is based on beneficiaries' expenses. That is, it has usually been the case that insurants can enjoy the benefit of insurance by paying insurance premiums to insurers. Predicated on such a profit structure, the conventional insurance management system up to the present has been therefore established where an insurant terminal, an insurer's terminal, and the insurance management device suffice as described in Patent Document 1.

However, while an insurant may receive compensation, such as an insurance payment, when a risk, for example, an accident and a disease, becomes apparent, the payoff worth insurance premium payment is less likely to be apparent for the insurants until the risk becomes apparent, which has been one of the obstacles for insurance purchase. Also, when the compensation in the event of accident is extended, the insurance premium naturally becomes expensive in proportion to the compensation. These issues are inevitable by the nature of insurance. Yet, if the compensation that the insurant can receive in the event of accident and the like could be maintained and the insurance premium paid by the insurant could be reduced even slightly, it is considered to lead to an increase in the number of insurance purchase.

The object of the present invention is to reduce the burden on a user (insurant), and to encourage the user to purchase of insurance or other equivalent services.

### Solutions to the Problems

The inventor of the present invention has made intensive studies for resolving the problems of the prior art as described above. As the result of that, it is found that imposing a part of or all the cost that the users are supposed to pay under ordinary circumstances upon purchasing a service such as insurance on sponsors other than insurers encourages the users to purchase the service. Then, having been conceived that the problems of the prior art can be resolved based on the finding as described above, the inventor has finalized the present invention. Specifically, the present invention has the following configuration.

The first aspect of the present invention relates to a management server. The management server of the present invention is a server device connected to a user terminal used by a user, an insurer's terminal used by an insurer, and a sponsor's terminal used by a sponsor through a communications network. Firstly, the management server receives information about an insurance product from the insurer's terminal. The information about the insurance product includes insurance details (such as coverage) and a purchase condition of the insurance product and the like. Also, the management server receives information about the purchase condition of the insurance products from the sponsor's terminal, that is, the business model run by the system of the present invention allows the sponsor to specify the purchase conditions of insurance products in return for covering insurance premium. Next, the management server determines whether to permit the user to purchase a service by referring at least in part to the purchase condition received from the sponsor's terminal when having received an application for purchasing the service from the user terminal. As used herein, the term “service” may mean either the same as or a different service from the insurance product described above. For example, if damage occurs to a user's owned product, a service provider running the management server receives insurance payments from an insurer, and may provide a part of or all insurance payments, or may provide services pertaining to product replacement and repairs using the insurance payments. The purchase conditions of services can be designed with reference to the information about insurance products in the management server received from the insurer's terminal and purchase conditions of the insurance products received from the sponsor's terminal.

The configuration described above ensures that the business model of reducing the cost of users by imposing the cost of purchasing services such as the insurance on the sponsor can be operated efficiently. Namely, the sponsor's intention will be at least in part reflected on the purchase conditions of services applied to users. For example, the sponsor allows to obtain user's personal information in return for covering the cost. Personal information of the users who purchase the same products is of great value in products marketing. For example, the sponsor company can use user's personal information for product development. Also, the sponsor company can launch effective advertisement to reach users directly at the timing of replacement purchase by informing products of own company as a potential replacement. On the other hand, users may purchase insurances or services similar thereto for free or at a lower price in exchange of providing own personal information, and thereby the increase in the number of purchase of these services can be expected.

Preferably, the management server according to the present invention receives information about the user together with the application for purchasing the service from the user terminal. The management server transmits the information about the user to the sponsor's terminal. This ensures that user's personal information and the like can be provided to the sponsor's terminal efficiently.

Preferably, the management server according to the present invention transmits billing information about a cost for covering a part of or all of an insurance premium of the insurance product to the sponsor's terminal. Thus, the insurance premium for insurance products is not only imposed on users, but also at least a part of that is imposed on the sponsor, which promotes user's purchase of service.

The second aspect of the present invention relates to service providing system. The service providing system include a user terminal used by a user, an insurer's terminal used by an insurer, a sponsor's terminal used by a sponsor, and a management server connected to the terminals through a communications network. In the service providing system according to the present invention, the insurer's terminal transmits the information about an insurance product to the management server. The sponsor's terminal transmits the information about a purchase condition of the insurance product to the management server. The management server determines whether to permit the user to purchase a service by referring at least in part to the purchase condition received from the sponsor's terminal when having received an application for purchasing the service from the user terminal.

The third aspect of the present invention relates to a service providing method. The service providing method is performed by a user terminal used by a user, an insurer's terminal used by an insurer, a sponsor's terminal used by a sponsor, and a management server connected to the terminals through a communications network. In the service providing method according to the present invention, the insurer's terminal transmits the information about an insurance product to the management server. The sponsor's terminal transmits the information about a purchase condition of the insurance product to the management server. The management server determines whether to permit the user to purchase a service by referring at least in part to the purchase condition received from the sponsor's terminal when having received an application for purchasing the service from the user terminal.

Next, another aspect of the management server will be described. Namely, the management server receives information about an insurance product from the insurer's terminal. Also, the management server determines whether to permit the user to purchase a service by referring at least in part to a purchase condition of the insurance product when having received an application for purchasing the service from the user terminal. Then, the management server may transmit information about the user to the sponsor's terminal when the user has been determined to be qualified to purchase the service. Thus, by transmitting user's personal information and the like to the sponsor's terminal, a part of or all the insurance premium for the insurance products may be collected from the sponsor company.

Next, another aspect of the service providing system will be described. Namely, in the service providing system, the insurer's terminal transmits information about an insurance product to the management server. The management server determines whether to permit the user to purchase a service by referring at least in part to a purchase condition of the insurance product when having received an application for purchasing the service from the user terminal. The management server transmits information about the user to the sponsor's terminal when the user has been determined to be qualified to purchase the service.

Next, another aspect of the service providing method will be provided. Namely, in the service providing system, the insurer's terminal transmits information about an insurance product to the management server. The management server determines whether to permit the user to purchase a service by referring at least in part to a purchase condition of the insurance product when having received an application for purchasing the service from the user terminal. The management server transmits information about the user to the sponsor's terminal when the user has been determined to be qualified to purchase the service.

### Effects of the Invention

The present invention ensures reducing a user's cost to promote purchase of services, such as an insurance.

### BRIEF DESCRIPTION OF THE DRAWINGS

FIG. 1 schematically illustrates an overall configuration of a service providing system.

FIG. 2 illustrates exemplary function blocks for terminal devices and a server device constituting the service providing system.

FIG. 3 illustrates exemplary data structures for respective tables provided in a management database.

FIG. 4 illustrates exemplary data structures for respective tables provided in a database for insurer.

FIG. 5 illustrates an exemplary design flow chart for purchase conditions of service.

FIG. 6 illustrates an exemplary examination flow chart for purchase of service.

### DESCRIPTION OF EMBODIMENTS

The following describes embodiments of the present invention using the drawings. The present invention is not limited to the embodiment described below and includes ones appropriately modified in an obvious range by those skilled in the art from the following embodiments.

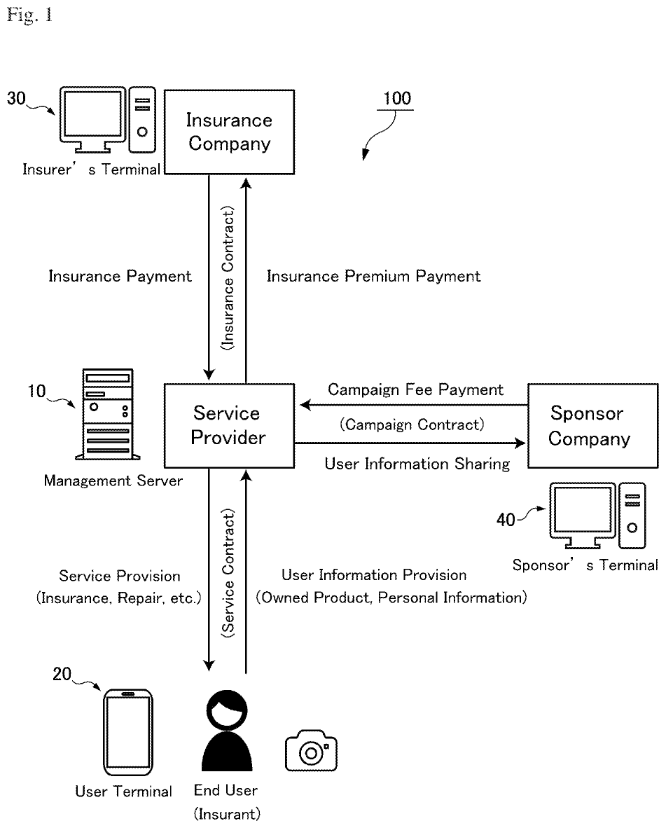

FIG. 1 illustrates an outline of a business model achievable by a service providing system 100 according to one embodiment of the present invention. This business model assumes an end user as an insurant and uses a free or low-cost insurance on the end user him/herself or his/her owned product as an incentive to obtain personal information of the end user him/herself and his/her owned product information while a sponsor company covers a part of or all the insurance premium in return for obtaining the end user's personal information and owned product information. Specifically, a service provider (policyholder) concludes an insurance contract with an insurance company by making the end user become an insurant. Insured subjects are the end user him/herself or his/her owned products and the insurance will compensate for diseases, accidents, hazards, and the like that occur to the end user or failures, losses, and the like that occur to his/her owned products (industrial products, such as a camera and an automobile). The service provider pays the insurance premium to the insurance company and in the case where an accident or the like that meets insurance conditions occur, the insurance company basically pays the insurance payment to the service provider. The insurance payment may be a replacement value of a product as an insured subject or be set at a fixed rate regardless of the product as the insured subject. On the other hand, benefits given by the service provider to the end user as the insurant, that is, the details of the insurance coverage may be the insurance payment or other services, such as product repair or alternative product replacement. Thus, a service contract is concluded between the end user and the service provider.

Also, prior to the insurance contract and the service contract, the service provider concludes a campaign contract with the sponsor company. In return for paying a campaign fee to the service provider, the sponsor company acquires personal information and owned product information of the end user as the insurant. The service provider uses the campaign fee received from the sponsor company to cover a part of or all the insurance premiums paid to the insurance company. In other words, the campaign fee that the service provider receives from the sponsor company may be the same amount as the insurance premium, or an amount lower or higher than the insurance premium. In a case where the campaign fee and the insurance premium are the same amount, the service provider may charge the end user a service fee (at least an amount lower than the insurance premium) as a commission. In a case where the campaign fee is lower than the insurance premium, the service provider can charge the end user an amount of the remaining portion of the insurance premium added with the commission as the service fee. On the other hand, in a case where the campaign fee is higher than the insurance premium (such as when the insurance premium and the commission are included in the campaign fee), the end user can enjoy the service from the service provider for free. Thus, a cost on the end user can be reduced by charging the sponsor company the campaign fee and by covering a part of or all the insurance premium with the campaign fee.

Also, as described above, in exchange for the sponsor company covering at least a part of the insurance premium that the end user is supposed to pay under ordinary circumstances, intentions of the sponsor company are reflected on purchase conditions and coverage details of the insurance contract (or the service contract) of which the insurant is the end user. For example, the sponsor company can specify the personal information and the owned product information obtained from the end user when concluding the contract or restrict the conditions and the coverage details at the purchase of the insurance so as to be advantageous for its own company. For example, the sponsor company tailors the insurance purchase conditions and the like to be advantageous for the company so as to enjoy a profit worth the payment of the campaign fee by limiting the insured subject to the company's own products or limiting the coverage details at property damage to replacement with company's own products.

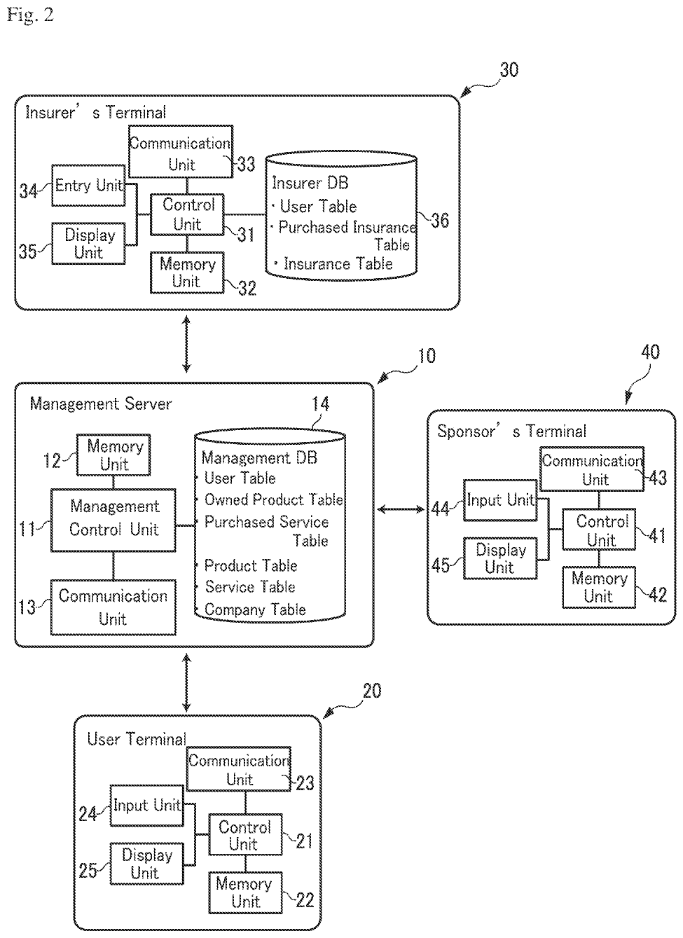

The service providing system 100 or a management server 10 that forms the core of the service providing system 100 according to the present invention is configured to execute information processing appropriate for operating the above business model. As illustrated in FIG. 1, the service providing system 100 includes the management server 10 used by the service provider (policyholder), a user terminal 20 used by the end user, an insurer's terminal 30 used by the insurance company, and a sponsor's terminal 40 used by the sponsor company. The management server 10 connects the user terminal 20, the insurer's terminal 30, and the sponsor's terminal 40 with one another through a communication network, such as the Internet. Also, FIG. 2 illustrates function blocks of the management server 10, the user terminal 20, the insurer's terminal 30, and the sponsor's terminal 20.

The management server 10 is a server device mainly used by the service provider in charge of operating this system and includes functions to execute information exchange with each of terminals 20, 30, 40, design process of service purchase conditions, or process of examination for service. The management server 10 can, for example, be configured by one or a plurality of publicly known web servers. Note that the web server may be physically built inside a data center or exist virtually in the cloud.

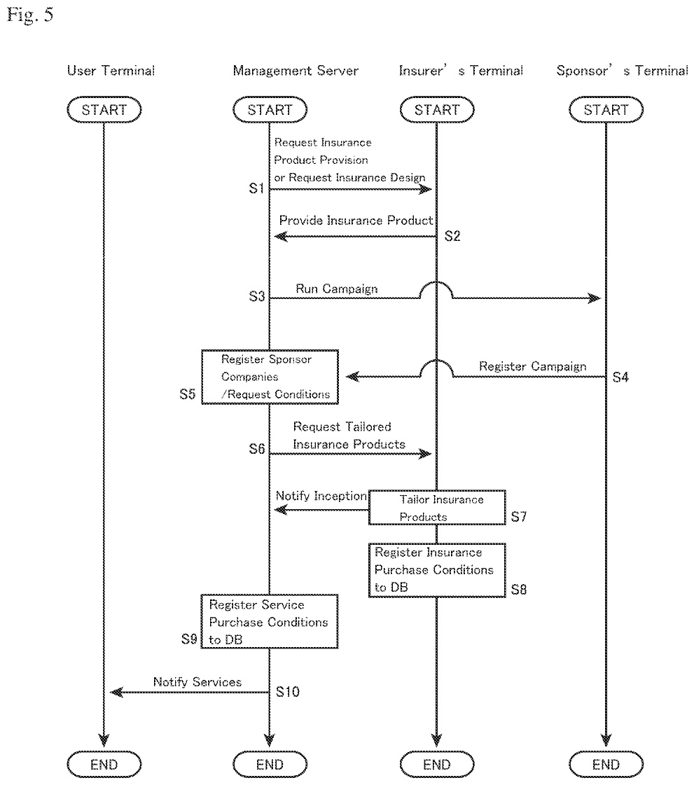

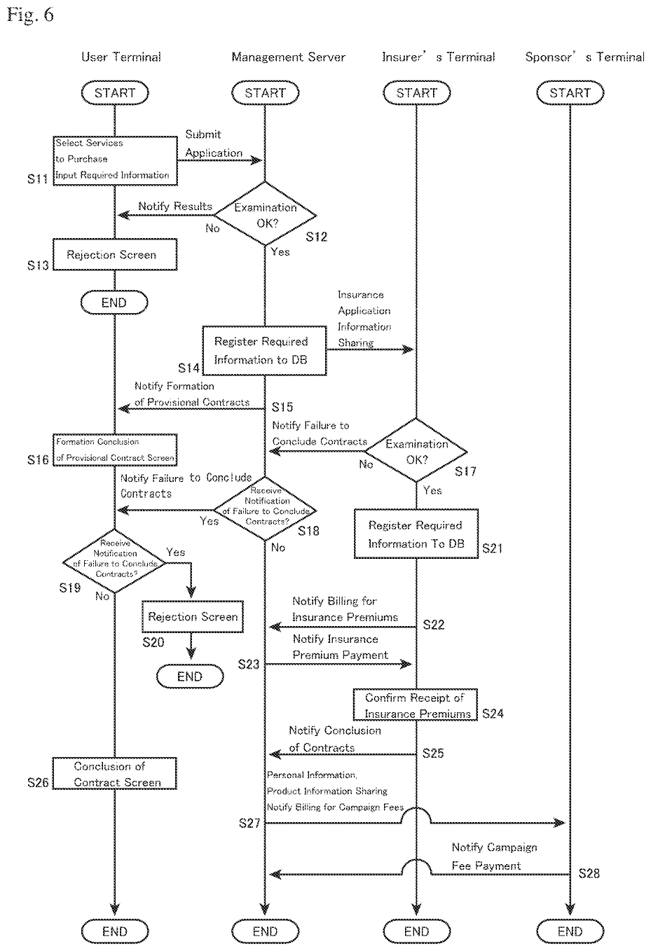

The management server 10 includes a management control unit 11, a memory unit 12, a communication unit 13, and a management database (DB) 14. The management control unit 11 of the management server 10 performs an operation process of this entire system illustrated in FIGS. 5 and 6 described later. The management control unit 11 is configured of processors, such as publicly known CPU. The memory unit 12 is a component that stores information used for computation processing and the like in the terminal control unit 11. The memory unit 12 stores a program that makes a general-purpose web server band function as the management server 10 according to the present invention. The management control unit 11 reads the program stored in the memory unit 12 and controls other components in accordance with this program. The management control unit 11 can appropriately write or read computation results according to the program into or from a memory. A storage function of the memory unit 12 can be achieved by a non-volatile memory, such as an HDD and an SDD. The memory function of the memory unit 12 can be achieved by a volatile memory, such as a RAM and a DRAM. The communication unit 13 is a component for transmitting and receiving information between the user terminal 20, the insurer's terminal 30, and the sponsor's terminal 40 through the Internet.

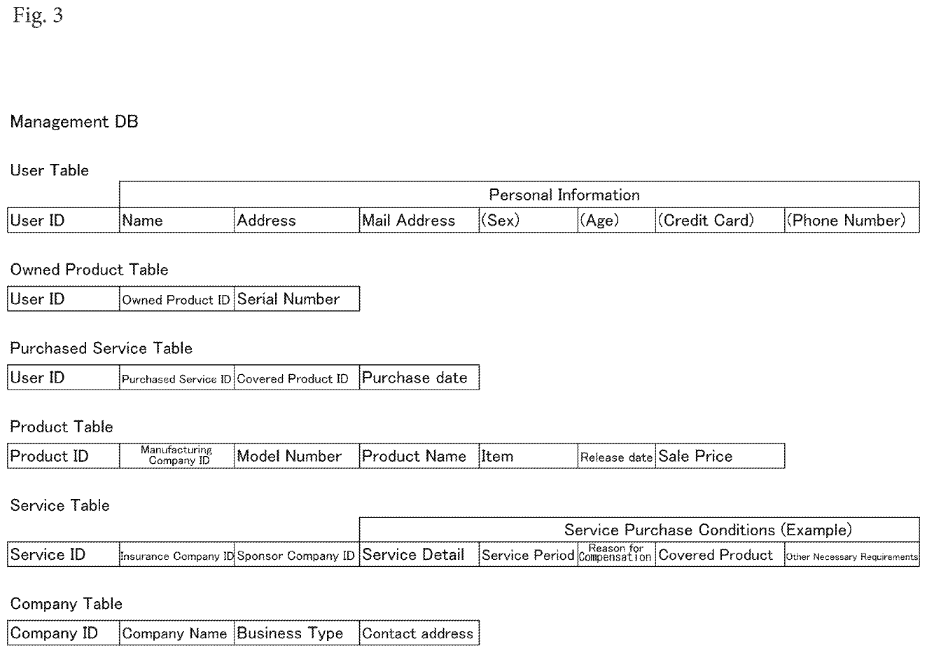

The management DB 14 is built up of various tables for managing information shared mainly by the insurer's terminal 30 and the sponsor's terminal 40 and information used for the user's service purchase examination. FIG. 3 illustrates an example of data structures of the tables included in the management DB 14. For example, the management DB 14 includes a user table, an owned product table, a purchased service table, a product table, a service table, and a company table.

The user table is a table for registering personal information by each end user. Specifically, the user table has fields for associating and storing personal information, such as name, address, and e-mail address of a user with a user ID unique to an end user as a primary key. Also, the user's personal information may include sex, age, payment information (credit card information), and telephone number.

The owned product table is a table for registering information regarding products owned by a user by each end user. Specifically, the owned product table has fields for associating and storing an owned product ID as a foreign key, a serial number of an owned product, and the like with the user ID as the primary key. The owned product ID is linked with the product ID as the primary key of the product table.

The purchased service table is a table for registering information regarding a service purchased by a user by each end user. The purchased service table has fields for associating and storing a purchased service ID as a foreign key, a covered product ID as a foreign key, a purchase date of the service, and the like with the user ID as the primary key. The purchased service ID is linked with a service ID as a primary key of the service table. Also, the covered product ID is linked with the product ID as the primary key of the product table. Therefore, by referring to the purchased service table, it is possible to specify which user has purchased which service and which product is set as a subject of the service (insured object).

The product table is a table for registering information regarding a product by each product. The product table, for example, has fields for associating and storing a manufacturing company ID as a foreign key, a model number of the product, product name, item (category, such as camera and mobile phone), release date of the product, sale price (suggested retail price), and the like with a product ID unique to the product as a primary key. The manufacturing company ID is linked with a company ID as a primary key of the company table.

The service table is a table for registering information on a sponsor company that cooperates in relation to a service and information regarding service purchase conditions by each service. The purchase conditions registered in this service table reflect the request of the sponsor company and the purchase conditions of the insurance product set by the insurance company. The service table has fields for associating and storing an insurance company ID as a foreign key, a sponsor company ID as a foreign key, and information regarding the service purchase conditions with the service ID unique to the service as a primary key. The insurance company ID is linked with the company ID as the primary key of the company table. For the insurance company ID, an ID unique to the insurance company that has concluded the insurance contract as the basis of each service is registered. The sponsor company ID is linked with the company ID as the primary key of the company table. For the sponsor company ID, an ID unique to the sponsor company that has concluded the campaign contract regarding each service is registered. Examples of the service purchase conditions include any required items specified by the sponsor company including service details, service periods, reasons for compensation, and covered products. The service details field is to register specific details of the service provided to the end user, and, for example, cash benefits and calculation method thereof, product repairs, or product replacements is registered. Also, the service period field is to register a time period for which the user can be provided with the service, and a specific period such as up to one year from the service purchase date and availability of its update are registered. The reason for compensation field is a field to register a reason as a cause for providing the service to the user, and a specific reason, such as a natural breakdown, submergence, theft, and natural hazards, is registered. The covered product field is a field to register a product as a subject of compensation, and, for example, a restriction, such as limited to products of the sponsor company, and a specific model number, product name, and item are registered. Note that the product to be a subject of compensation may be a product of another company, not only products of the sponsor company. For example, the service purchase conditions may be defined with an aim to replace products of other companies owned by the user with products of the sponsor company. Also, the subject of compensation is not limited to a product but may be the end user him/herself (for example, human diseases, accidents, or hazards). Also, in the other required item field, personal information, product information, and the like provided to the sponsor company when the end user purchases a service are registered. For example, the sponsor company can request such that personal information, such as the name and address of the end user registered in the user table and information regarding the user's owned product registered in the owned product table are shared. In the required item field, other than the above, various conditions requested by the sponsor company can be registered, as necessary.

The company table is a table for registering information regarding a business type and a contact address by each company. The company table has fields for associating and storing a company's name, a business type, a company classification, and a contact address with the company ID as a primary key. In the company table, a classification between “insurance companies,” “sponsor companies,” and “other” companies that are neither of them (such as manufacturing companies that produce and sell products as the insured objects) in the system is registered.

The user terminal 20, insurer's terminal 30, and sponsor's terminal 40 are terminal devices that can be respectively used by the end user, the insurance company, and the sponsor company, and have a communication function with the management server 10. For these terminals 20, 30, 40, a general-purpose desktop PC or portable information terminals, such as a smart phone or a tablet type terminal, can also be used. Each of the terminals 20, 30, 40 may include an application program dedicated for this system and communicate with the management server 10 through this program or may access a website provided by the management server 10 through a general-purpose web browser and communicate with the management server 10 through this website.

The respective terminals 20, 30, 40 have control units (21, 31, 41), memory units (22, 32, 42), communication units (23, 33, 43), input units (24, 34, 44), and display units (25, 35, 45) as a common function. The control unit executes a process to control other components included in respective terminals. As the control unit, processors, such as a CPU and a GPU, can be used. The control unit reads the application program stored in the memory unit and controls other components in accordance with this application program. Also, the control unit can appropriately write or read the computation results into or from the memory unit according to the application program. The memory unit is a component to store information used for computation processing or the like in the control unit. The memory unit stores an application program that makes an information terminal, such as a general-purpose PC, function as a terminal in the service providing system 100 (user terminal, insurer's terminal, sponsor's terminal) according to the present invention. The storage function of the memory unit can be achieved by a non-volatile memory, such as an HDD and an SDD. The memory function of the memory unit can be achieved by a volatile memory, such as a RAM and a DRAM. The communication unit is a component for transmitting and receiving information with the management server through a communication line, such as the Internet. The input unit is a component for accepting an input of information to each terminal. The information input through the input unit is conveyed to the control unit. For the input unit, publicly known input devices, such as a touch panel, a button, a cursor, a microphone, a keyboard, and a computer mouse, can be employed. The display unit is a display that displays prescribed images and the like according to the control of the control unit. Publicly known displays, such as a liquid crystal display and an organic EL, may be used for the display unit. Also, a touch panel display may be configured by stacking the touch panel onto the display.

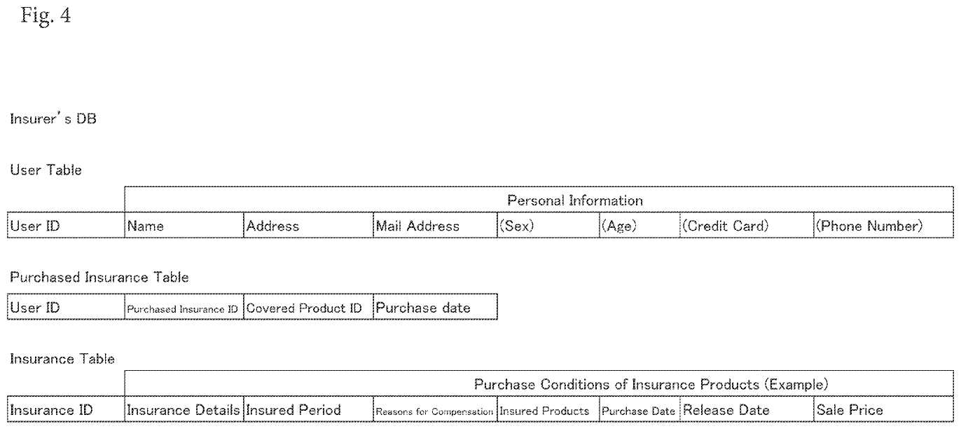

In this system, the insurer's terminal 30 includes an insurer database (DB) 36 in addition to the above common functions. The insurer DB 36 is built of various tables for managing information regarding the insurant (end user), information regarding the insurance purchased by the insurant or information regarding the purchase conditions of the insurance. FIG. 4 illustrates an example of data structures of tables included in insurer DB 36. The insurer DB 36 includes, for example, a user table, a purchased insurance table, and an insurance table.

In the user table of the insurer DB 36, information similar to that in the user table of the management DB 14 described above is basically registered. The user table of insurer DB 36 may be made by uniquely registering information in the insurer's terminal 30 or sharing information registered in the user table with the insurer's terminal 30 from the management server 10. Also, a common user ID may be assigned to the same end user such that information can be shared easily between the management server 10 and the insurer's terminal 0.

The purchased insurance table is a table for registering information regarding the insurance products set with a user as an insurant by each end user. The purchased insurance table has fields for associating and storing a purchased insurance ID as a foreign key, a covered product ID as a foreign key, and a purchase date of the insurance with the user ID as a primary key. The purchased insurance ID is linked with the insurance ID as a primary key of the insurance table. Also, the covered product ID is linked with the product ID as the primary key of the product table disposed in the management DB 14 of the management server 10. Therefore, by accessing the management server 10 as necessary, the insurance terminal 30 can acquire the product information registered in the product table of the management server 10. Also, by referring to the purchased insurance table, it is possible to specify which user is set as the insurant of which insurance product and which product is set as (the insured objects).

The insurance table is a table for registering information regarding purchase conditions of an insurance product by each insurance product. These insurance purchase conditions may be basically designed uniquely by the insurance company or may be conditions tailored at the request of the sponsor company as described later. The insurance table has fields for associating and storing information regarding the insurance purchase conditions with the insurance ID unique to the insurance product as a primary key. Examples of the insurance purchase conditions include the insurance details, insured period, reason for compensation, insured product, purchase date of the insured product, release date, sale price, and the like. In the insured details field, an amount of the insurance payment and its calculation method, an insurance premium charged after concluding the insurance and its calculation method, or the like is registered. Also, the insured period field is to register an insurance contract period, and a specific time period, such as one year from a starting date, such as an insurance purchase date, a product purchase date, or a release date of the product, and availability of an update are registered. The reason for compensation field is a field to register the reasons as the causes of providing the insurance compensation, and a specific reason, such as a natural breakdown, submergence, theft, and natural hazards, is registered. The insured product field is a field to register information regarding the products as the subject of compensation. Note that the subject of compensation is not limited to a product, but may be the insurant him/herself (such as human diseases, accidents, or hazards). A release date and a sale price of the insured product are respectively registered in the release date field and the sale price field.

Subsequently, with reference to FIG. 5, an exemplary flow chart for designing purchase conditions of services provided to end users will be described. The flow chart in FIG. 5 illustrates information processing from designing purchase conditions of services and the like based on the requests from the sponsor company until notifying end users of the conditions.

Firstly, the service provider attempts to provide end users with insurances or services similar thereto uses the management server 10 to notify the insurer's terminal 30 owned by the insurance company of information about the needs of the service provider itself to make a request for designing and providing an insurance product that suits the needs (Step S1). In the insurance industry, the party corresponding to a “service provider” as used herein is mainly placed within one of the two types, an “insurance agency” (including an insurance intermediary (insurance broker)) and a “contractor of a group insurance policy.” The insurance agency directly provides end users with insurance products made by insurance companies. Therefore, it is shown as “insurance product provision request” in FIG. 3. Contrarily, the contractor of a group insurance policy prompts its group members and the like to join the group insurance policy where they are designated as an insurant. Such contractor does not only offer the existing insurance products provided by the insurance company, but also has insurance products designed to suit the needs of the group. Therefore, it is shown as “insurance design request” in FIG. 3.

When having received the requests from the service provider, the insurance company selects an insurance product among the existing ones or designs a new one, then notifies the management server 10 of information about the insurance product that suits the needs of the service provider through the insurer's terminal 30 (Step S2). Such insurance product information includes purchase conditions, compensation details, and the like of the insurance product. Yet, in this phase, the purchase conditions of the insurance product and the like are generally established uniquely by the insurance company.

Next, the service provider uses the management server 10 to notify the sponsor's terminal 40 used by a potential sponsor company of information about the insurance products and the like recommended by the insurance company. Upon providing end users with such insurance products, the service provider then solicits a sponsorship from companies request to share end users' personal information and information about products end users own, which are retrieved during the course of providing insurance products to end users (Step S3). The companies requesting to register such a campaign uses the sponsor's terminal 40 to notify the management server 10 of their request for registration (Step S4). In registration for the campaign, the management server 10 accepts a request for specific insurance products and services similar thereto provided to end users. The sponsor company transmits such request to the management server 10 by inputting the request to the sponsor's terminal 40. Possible requests made by sponsor companies for the service details provided to end users are, for example, to be limited to perform replacement to the products of the company in the event of failure of a user's owned product, and to be limited to cover the company's products as the insured products; and/or to specify personal information and the like which the sponsor company requests to retrieve from the end users. Requests from sponsor companies are not limited to those cited herein, and sponsor companies are given a discretion to a certain extent to notify service providers of their requests. When having received request information with the notification of registration for a campaign from the sponsor company, the management server 10 registers information of the company to the management DB 14 and temporarily stores request information in the memory unit 12 (Step S5).

Next, the service provider uses the management server 10 to notify the insurer's terminal 30 of the accepted request information from the sponsor company, and to make a request for a tailored insurance product to reflect the details of the request (Step S6). When having received such a request, the insurance company tailors purchase conditions of the insurance product and the service, scope of coverage (natural breakdown, property damage, natural disasters, disease, injury, and the like), covered products (including in personam), covered periods, and the like (Step S7). Also, the service provider uses the insurer's terminal 30 to notify the management server 10 of the provision of the tailored insurance product is started. Also, as for the insurer's terminal 30, information about the tailored insurance product after taking account of the requests from the sponsor company is registered in the insurance table of the insurer DB 36 (Step S8). Information registered in the insurance table includes information about the insurance details and purchase conditions of insurance as described above.

After receiving notification that the provision of the tailored insurance product is started, the management server 10 registers service purchase conditions, service details, and the like according to the insurance product, in the service table of the management DB 14 (Step S9). Specifically, registration in the service table involves the conditions applied to end users to purchase this service, together with the company ID for the insurance company providing the insurance products and the company ID for the sponsor company having registered for the campaign about such an insurance product. The conditions for service purchase to be registered in the service table of the management server 10 and the conditions for insurance purchase to be registered in the insurance table of the insurer's terminal 30 may be the same or different. As described above, insurance contract is concluded between the insurance company and the service provider. In the insurance table, the purchase conditions of the insurance product and compensation details for such contract are registered. Basically, the compensation made by the insurance company to the service provider is financial benefits. On the other hand, service contract is concluded between the end user and the service provider. In the service table, the service purchase conditions and service details for such contract are registered. For example, for end users, the service provider may provide services other than financial benefits, such as replacement of a faulty product or other equivalent. Also, to avoid the situation where an insurance contract has not yet concluded between the service provider and the insurance company, regardless of that a service contract has been concluded between the service provider and the end user, purchase conditions of services may be more restricted than purchase conditions of insurance.

As described above, after determining the purchase conditions and the compensation details for the service that can be provided to the use, the service provider uses the management server 10 to transmit notification information of the service to the user terminal 20 owned by the end user (Step S10). A service notification method includes, for example, the method for notifying notification information through the dedicated application program installed in the user terminal 20, the method for notifying the user terminal 20 terminal of the notification information by e-mail, or the method for notifying the user terminal 20 of the notification information through the website exclusive for the members.

Subsequently, with reference to FIG. 6, an exemplary service purchase examination flow chart will be described. The flow chart in FIG. 6 illustrates the information processing from examining whether to permit the user to purchase the service or not when the user applies for purchase of the service until billing for the contract fees and the campaign fees after the determination of purchase.

As illustrated in FIG. 6, the end user uses the user terminal 20 to select a service the user requests to purchase, and thereafter, to input information required to purchase the service (Step S11). The selection screen of the purchased service and the input form of required information may be provided to the end users through the application program of the user terminal 20 or may be provided to the end users through the website provided by the management server 10. Also, information required for purchasing services differs according to services. Namely, the management server 10 simply refers to the service table of the management DB 14 and provides the user terminal 20 with the input form to input required information at purchasing the service. Specifically, to determine whether or not the end user satisfies the service purchase conditions registered in the service table, the end user is requested to input information corresponding to these purchase conditions. Also, when the sponsor company requests to obtain names of products owned by the user together with, for example, sex and age of the user, the end user is requested to input the information requested by these sponsor companies as a condition for applying for the service.

Next, after receiving the application for purchase of services from the end user, the management server 10 examines whether to permit the purchase of services based on information input by the end user (Step S12). As describe above, whether to permit purchase of services is determined in accordance with the purchase conditions of the services registered in the service table. The purchase conditions of the services in this service table have at least in part reflected the requests of the sponsor company received in Step S4 described above. For example, when products that can be covered by the services are limited to the products manufactured and sold by the sponsor company, the management server 10 determines whether or not the product for which the end user has applied for purchasing the service meets this condition. Thus, the management server 10 determines whether to permit the end user to purchase the services based on the service purchase conditions where the requests of the sponsor company has been reflected.

When the management server 10 has determined, as a result of examination in Step S12, that information input by the end user does not meet the service purchase conditions, the management server 10 notifies the user terminal 20 of the result. In this case, the rejection screen for application is displayed on a display unit 25 of the user terminal 10 (Step S13). When the application is rejected, the examination flow chart illustrated in FIG. 6 is terminated.

On the other hand, when the management server 10 has determined, as a result of examination in Step S12, that information input by the end user meets the service purchase conditions, the management server 10 registers information input by the end user to the management DB 14 (Step S14). For example, the management server 10 registers information in the personal information field of the user table and each field in the owned product table based on information input by the end user. Subsequently, to the insurer's terminal 30, the management server 10 transmits the notification of application for the insurance products corresponding to the services of which the end user has applied for purchase. Namely, the service provider applies for the insurance products where end users are designated as an insurant to the insurance company. Also, at this time, the management server 10 may provide require information to the insurer's terminal 30. For example, because information registered in the user table in the management server 10 is also useful for the insurance company, the management server 10 may transmit various kinds of information registered in this user table to the insurer's terminal 30. Further, the management server 10 notifies the user terminal 20 of a service contract having been provisionally formed (Step S15). In this phase, because an insurance contract has not yet been formed between the insurance company and the service provider, a service contract between the service provider and the end user should also be provisional. When the user terminal 20 receives the notification of formation of provisional contracts from the management server 10, the user terminal 20 displays the screen representing the formation of provisional contracts on the display unit 25 (Step S16). When the management server 10 transmits the notification of failure to form contracts to the user terminal within a certain period of time after the formation of provisional contracts, the contract between the service provider and the end user will be canceled. In case that the above-described notification of failure to form contracts is not transmitted after a certain period of time, the screen representing that the contract is officially formed is displayed on the display unit 25 of the user terminal 20 (Step S26).

When the insurer's terminal 30 receives the notification of application for purchase of the insurance products where end users are designated as the insured from the management server 10, the insurer's terminal 30 examines whether or not the purchase conditions of the insurance registered in the insurance table of the insurer DB 36 are met (Step S17). This purchase conditions of insurance in the insurance table are tailored in part based on the requests received in Step S4 describe above from the sponsor company. For example, when the products that can be covered by the insurance are restricted to the ones within one year from the release date (or the purchase date), the insurer's terminal 30 determines whether the insured product meets this condition. Thus, the insurer's terminal 30 determines whether to permit the conclusion of insurance contracts where end users are designated as the insured based on the purchase conditions of the insurance tailored according to the requests of the sponsor company.

When the insurer's terminal 20 has determined, as a result of examination in Step S17, that the predetermined purchase conditions of the insurance are not met, the insurer's terminal 20 notifies the management server 10 of a failure to conclude the insurance contract. The management server 10 determines whether or not the notification of failure to conclude contracts is received from the insurer's terminal 30 within a certain period of time (Step S18). When the notification of failure to conclude contracts has been determined to be received, the management server 10 forwards the notification of failure to the user terminal 20. Similarly, the user terminal 20 determines whether or not the notification of failure to conclude contracts is received from the management server 10 within a certain period of time (Step S19). When the notification of failure has been determined to be received, the screen representing the rejection of the application for service purchase is displayed on the display unit 25 (Step S20). When the application is rejected, the examination flow chart illustrated in FIG. 6 is terminated.

On the other hand, when the insurer's terminal 30 has determined, as a result of examination in Step S17, that insurance contracts where end users are designated as an insurant meet the contract conditions, the insurer's terminal 30 registers required information to the insurer DB 36 (Step S21). For example, the insurer's terminal 30 registers personal information fields of the user table, and registers information in each field of the purchased insurance table based on the shared information from the management server 10.

Next, the insurer's terminal 30 notifies the management server 10 of billing for insurance premiums for the concluded insurance product (Step S22). The insurance premiums of the insurance products may be the amount determined in advance by the insurance company or may be the amount tailored according to the request of the sponsor company. When the management server 10 receives the notification of billing for insurance premium, the service provider arranges for the insurance premium payment to the insurance company. Also, after completion of the payment arrangement, the management server 10 transmits the notification of the completion of payment to the insurer's terminal 30 (Step S23). The insurer's terminal 30 then confirms receipt of the insurance premium (Step S24), and thereafter, transmits the notification of conclusion of insurance contracts to the management server 10 (Step S25). With this notification, the insurance contract is officially concluded between the service provider and the insurance company. Also, as described above, when the notification of failure to form contracts has not been transmitted to the user terminal 20 after a certain period of time, the screen representing that the contract has been officially formed is displayed on the display unit 25 of the user terminal 20 (Step S26). In this phase, the service contract is officially concluded between the service provider and the end user. It is one of the characteristics that, in the system in the present invention, service contracts are independently formed between the end user and the service provider, regardless of the insurance premium payment from the service provider to the insurance company, and the confirmation of receipt of the insurance premium by the insurance company. Therefore, service provision to end users can be started in a prompt manner.

Also, after the conclusion of the insurance contract, the management server 10 notifies the sponsor's terminal 30 of billing for the campaign fees as well as transmitting personal information of the end user and information about end user's owned product that the sponsor company desires to obtain in advance (Step S27). For example, the management server 10 may simply extract information that the sponsor company wants among information registered in the user table and the owned product table in the management DB 14 and transmit the information to the sponsor's terminal 30. Also, when the sponsor's terminal 30 receives the notification of billing for the campaign fees, the sponsor company arranges for the campaign fee payments for the service provider. Also, after the completion of payment arrangement, the sponsor's terminal 30 transmits the notification of completion of payment to the management server 10 (Step S28). Having proceeded this far, the examination flow chart for service purchase is terminated.

In the present specification, the embodiments of the present invention have been described above by referring to the drawings to express the contents of the present invention. However, the present invention is not limited to the above-described embodiments, and encompasses changed configurations and improved configurations obvious to person skilled in the art based on the matters described in the present specification.

### REFERENCE SIGNS LIST

| | |
|---|---|
| 10 . . . Management server | 20 . . . User terminal |
| 30 . . . Insurer's terminal | 40 . . . Sponsor's terminal |
| 100 . . . Service providing system | |

1. A management server connected to a user terminal used by a user, an insurer's terminal used by an insurer, and a sponsor's terminal used by a sponsor through a communications network, wherein
the management server:
receives information about an insurance product from the insurer's terminal;
receives information about a purchase condition of the insurance product from the sponsor's terminal; and
determines whether to permit the user to purchase a service by referring at least in part to the purchase condition received from the sponsor's terminal when having received an application for purchasing the service from the user terminal.

2. The management server according to claim 1, wherein
the management server receives information about the user together with the application for purchasing the service from the user terminal, and
the management server transmits the information about the user to the sponsor's terminal.

3. The management server according to claim 1, wherein
the management server transmits billing information about a cost for covering a part of or all of an insurance premium of the insurance product to the sponsor's terminal.

4. A service providing system comprising:
a user terminal used by a user;
an insurer's terminal used by an insurer;
a sponsor's terminal used by a sponsor; and
a management server connected to the terminals through a communications network, wherein
the insurer's terminal transmits information about an insurance product to the management server,
the sponsor's terminal transmits information about a purchase condition of the insurance product to the management server, and
the management server determines whether to permit the user to purchase a service by referring at least in part to the purchase condition received from the sponsor's terminal when having received an application for purchasing the service from the user terminal.

5. A method of providing a service performed by a user terminal used by a user, an insurer's terminal used by an insurer, a sponsor's terminal used by a sponsor, and a management server connected to the terminals through a communications network, the method comprising:
a step of transmitting information about an insurance product to the management server by the insurer's terminal;
a step of transmitting information about a purchase condition of the insurance product to the management server by the sponsor's terminal; and
a step of determining whether to permit the user to purchase a service by referring at least in part to the purchase condition received from the sponsor's terminal by the management server when having received an application for purchasing the service from the user terminal.

6. A management server connected to a user terminal used by a user, an insurer's terminal used by an insurer, and a sponsor's terminal used by a sponsor through a communications network, wherein
the management server:
receives information about an insurance product from the insurer's terminal;
determines whether to permit the user to purchase a service by referring at least in part to a purchase condition of the insurance product when having received an application for purchasing the service from the user terminal; and
transmits information about the user to the sponsor's terminal when the user has been determined to be qualified to purchase the service.

7. A service providing system comprising:
a user terminal used by a user;
an insurer's terminal used by an insurer;
a sponsor's terminal used by a sponsor; and
a management server connected to the terminals through a communications network, wherein
the insurer's terminal transmits information about an insurance product to the management server, and
the management server determines whether to permit the user to purchase a service by referring at least in part to a purchase condition of the insurance product when having received an application for purchasing the service from the user terminal, and the management server transmits information about the user to the sponsor's terminal when the user has been determined to be qualified to purchase the service.

8. A method of providing a service performed by a user terminal used by a user, an insurer's terminal used by an insurer, a sponsor's terminal used by a sponsor, and a management server connected to the terminals through a communications network, the method comprising:
a step of transmitting information about an insurance product to the management server by the insurer's terminal; and
a step of determining whether to permit the user to purchase a service by referring at least in part to a purchase condition of the insurance product when having received an application for purchasing the service from the user terminal, and transmitting information about the user to the sponsor's terminal when the user has been determined to be qualified to purchase the service by the management server.
